(19) United States
(12) Patent Application Publication
(10) Pub. No.: US 2015/0134558 A1
(43) Pub. Date: May 14, 2015

(54) METHOD AND SYSTEM FOR TRACKING SHIPPING CARGO

(71) Applicant: TRADENET COMMERCIAL NETWORKING LTD., Middlesex (GB)

(72) Inventor: Duncan MURRAY, Middlesex (GB)

(21) Appl. No.: 14/539,373

(22) Filed: Nov. 12, 2014

(30) Foreign Application Priority Data
Nov. 11, 2013 (GB) 1319825.4

(51) Int. Cl. G06Q 10/08

(52) U.S. Cl. CPC G06Q 10/0833
USPC 705/333

(57) ABSTRACT

The present invention relates to a method of tracking cargo at a processing system, including: determining whether a vessel has berthed at one of a plurality of berths, each berth tagged with a commodity type; receiving information about the vessel; determining whether the vessel has called at a port; and utilising the berth tag and information about the vessel to calculate the quantity of a commodity delivered between the berth and the port. A system for tracking cargo is also disclosed.

### FIELD OF INVENTION

The present invention is in the field of cargo tracking. In particular, but not exclusively, the present invention relates to tracking shipping cargo.

### BACKGROUND

Cargo vessels travel between shipping ports carrying cargo from one port to off-load at another.

It is useful for other parties, such as commodities traders, to be aware of the types and quantities of cargo being shipping from port to port.

Current methods to track cargo rely on reports of vessel sightings from port agents or broker reports to identify vessels within a port and the cargos they carry. These methods come with numerous disadvantages including unreliable or incomplete information.

An accurate system for tracking cargo flows is, therefore, desirable.

It is an object of the present invention to provide a cargo tracking system which overcomes the disadvantages of the prior art, or at least provides a useful alternative.

### SUMMARY OF INVENTION

According to a first aspect of the invention there is provided a method of tracking cargo at a processing system, including:

determining whether a vessel has berthed at one of a plurality of berths, each berth tagged with a commodity type;

receiving information about the vessel;

determining whether the vessel has called at a port; and

utilising the berth tag and information about the vessel to calculate the quantity of a commodity delivered between the berth and the port.

The information may include draught information received from the vessel.

The information may include information relating to the capacity and/or size of the vessel.

The step of determining whether the vessel is berthed may include determining whether location coordinates for the vessel correspond to the location coordinates for the berth. The berth correspondence process may utilise the length of the vessel. The berth correspondence process may utilise the type of berth. The step of determining whether the vessel is berthed may include determining whether the velocity of the vessel is below a predefined threshold.

The step of determining whether the vessel has called at the port may include determining whether location coordinates for the vessel correspond to a location within a polygon area defined for the port. The port correspondence process may utilise the length of the vessel. The step of determining whether the vessel has called at the port may include determining whether the velocity of the vessel is below a predefined threshold.

The vessel may depart from the berth for arrival at the port.

According to a further aspect of the invention there is provided a system for tracking cargo, including: a processing system configured for determining whether a vessel has berthed at one of a plurality of berths, each berth tagged with a commodity type, receiving information about the vessel, determining whether the vessel has called at a port, and utilising the berth tag and information about the vessel to calculate the quantity of a commodity delivered between the berth and the port;

a berth database configured for storing information about a plurality of berths; and

a port database configured for storing information about a plurality of ports.

Other aspects of the invention are described within the claims.

### BRIEF DESCRIPTION OF THE DRAWINGS

Embodiments of the invention will now be described, by way of example only, with reference to the accompanying drawings in which:

FIG. 1: shows a block diagram illustrating a system in accordance with an embodiment of the invention;

FIG. 2: shows a flow-chart illustrating a method in accordance with an embodiment of the invention;

FIG. 3: shows a map illustrating berths tagged with commodities in accordance with an embodiment of the invention;

FIG. 4: shows a map illustrating a port zone polygon in accordance with an embodiment of the invention;

FIG. 5: shows a vessel at a berth illustrating the location of a GPS device;

FIG. 6: shows a flow-chart illustrating a berth tracking method in accordance with an embodiment of the invention;

FIG. 7: shows a vessel at a berth illustrating a berth tracking method system in accordance with an embodiment of the invention; and

FIG. 8: shows a flow-chart illustrating a cargo tracking method in accordance with an embodiment of the invention.

### DETAILED DESCRIPTION OF PREFERRED EMBODIMENTS

The present invention provides a cargo tracking system.

The present invention may infer the type of cargo a vessel is carrying (or has previously carried) by associating berth locations with cargo types and then recording vessels visiting those berths using vessel GPS locations. The vessel's voyage from that berth to its next port may be recorded with the cargo type e.g. a vessel visiting a berth known to load coal would then have cargo type of coal recorded on its voyage from that berth to its next port.

A vessel may be determined to be moored at a berth by comparing various statistics about the vessel to its proximity to the berth. The GPS location of the vessel may be compared to the geo-referenced location of the berth and, using known data like the vessel's current speed, length of the vessel and the type of the berth, it may be determined whether the vessel is moored at the berth. The arrival and departure date/time stamps of the vessel moored at the berth can then be used to create ‘berth callings’.

A vessel's arrival and departure at a port may be determined by comparing the GPS location of the vessel to be within a geo-referenced zone around the port and using known data like the vessel's current speed to eliminate ‘sail throughs’ as much as possible. A ‘sail through’ is when a vessel passes through a geo-referenced port zone but does not actually call at the port—this often occurs at ports close to shipping lanes.

Using the berth departure and next port arrival a vessel's voyage record may be created with the inferred cargo. The vessel's size and capacity, and/or actual draught measurements, may also be used to estimate the size of the cargo on board.

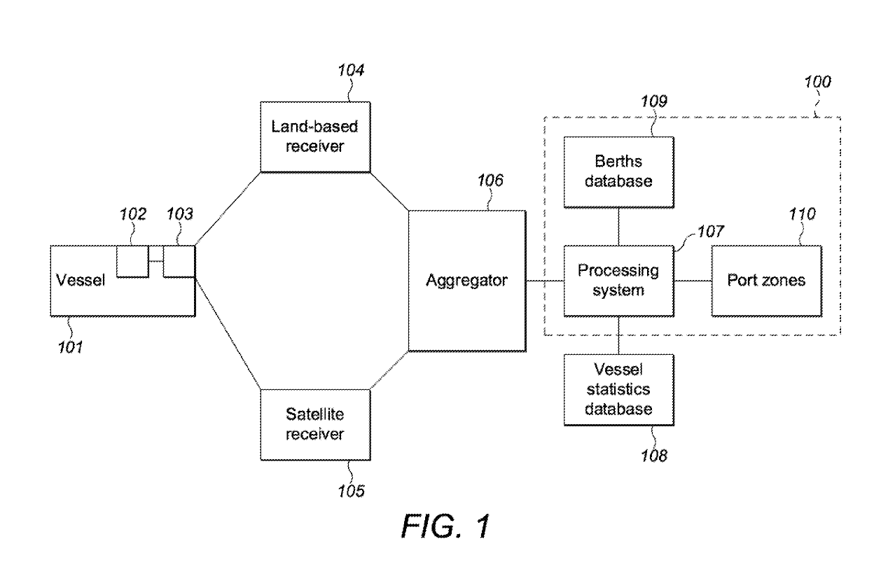

In FIG. 1, a system 100 in accordance with an embodiment of the invention is shown.

A vessel 101 is shown. The vessel 101 may include a location detection device 102, such as a GPS device, to determine current location coordinates for the vessel 101.

The vessel 101 may include a transmitter 103 to transmit messages for receipt by a receiver 104 or 105. The messages may include the location coordinates for a vessel 101, an identifier for the vessel 101 and/or information about the vessel 101. The messages may be time-stamped.

A land-based receiver 104 and a satellite receiver 105 are shown. Either receiver 104 or 105 may receive messages from the vessel 101 and relay them to an aggregator system 106.

The aggregator system 106 may compile messages from a plurality of vessels to provide a database of time-stamped location coordinates for the vessels and/or information about the vessel at each location coordinate. The aggregator 106 may provide an interface to receive requests for data within the database and transmit that data to the requesting systems.

A processing system 107 is shown. The processing system 107 may request vessel coordinates and/or information about a vessel 101 using a vessel identifier. The vessel identifier may uniquely identify a vessel. The processing system 107 may obtain vessel data associated with the vessel identifier. The vessel data may be obtained from a vessel statistics database 108. The vessel statistics database 108 may be local to the processing system or remote. The vessel data may include the length, the capacity, and/or the size of the vessel associated with the vessel identifier. The vessel data may include information about the type of vessel, for example, whether the vessel is a bulk carrier or a tanker.

The processing system 107 may be configured to process the vessel data and utilise the processed vessel data in conjunction with the received vessel coordinates to determine whether the vessel is berthed at one of a plurality of berth locations. The berth locations may be retrieved from a berth database 109. The berth locations may be associated with other berth information, such as whether the berth is fixed or floating.

The processing system 107 may be configured to determine whether the vessel is berthed by determining whether a berth location falls within a circle centred at the location coordinates of a radius of the processed vessel length. If multiple berth locations fall within the circle, the closest berth location is selected. Further vessel information may be received such as velocity of the vessel. The velocity of the vessel may also be used to determine whether the vessel is berthed if the velocity of the vessel is below a predefined threshold.

The vessel information may be received from the vessel 101 via the aggregator system 106.

The length of the vessel may be processed in relation to the berth, for example, whether the berth is fixed or floating—where the berth is floating, a predefined length may be added to the vessel length. The length of the vessel may be processed in relation to the vessel data, for example, whether the vessel is a bulk carrier or a tanker—where the vessel is a bulk carrier, a predefined length may be added to the vessel length. The length of the vessel may be processed in relation to the length of the vessel obtained, for example, if the length of the vessel is outside a range, such as 0 m to 500 m, then a predefined length for the vessel may be assigned.

In an alternative embodiment, the location of the vessel may be determined externally to the vessel, for example, by a triangulation mechanism.

In an alternative embodiment, rather than calculating vessel moorings, the processing system 107 may receive notifications of when and at which berths the vessels are moored.

The processing system 107 may be further configured to determine whether the location coordinates for a vessel are within a port zone of a plurality of port zones. The port zones may be retrieved from a port zone database 110. The port zones may comprise one or more areas defined by polygon. The port zone may be defined to indicate whether a vessel has called on a port or anchorage.

The combination of berth and port/anchorage calling can be used by the processing system 107 to create a journey for the vessel.

Each berth can be tagged within the berth database 109 with information denoting the commodity that the berth loads/unloads.

The information about the vessel may be received by the processing system 107 prior to the vessel arriving at the berth/port, and/or after the vessel has left the berth/port. The information about the vessel may be received from the vessel, for example draught information, or it may be received from the vessel statistics database 108, for example vessel size and/or capacity.

The processing system 107 may utilise the journey created along with the berth tagging and information about the vessel to determine how much of a particular commodity was shipped between the berth and the port.

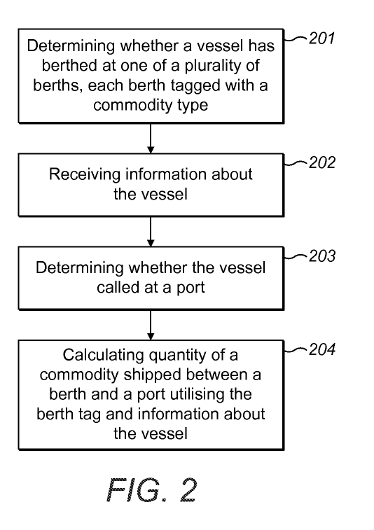

FIG. 2 shows a method in accordance with an embodiment of the invention.

In step 201, a vessel is determined to have berthed at one berth of out of a plurality of berths. Each berth is tagged with a commodity type.

In step 202, information is received about the vessel. The information may be draught information from the vessel showing how low the vessel is in the water, or the vessel information may be capacity or size information received from the vessel statistics database.

In step 203, the vessel is determined to have arrived at a port.

In step 204, the tagged berth and vessel information are used to calculate the quantity of the commodity delivered between the berth and the port.

It will be appreciated that the above steps are not necessarily sequential and that the vessel may arrive at the port and then arrive at the berth, in which case the commodity can be determined as moving from the port to the berth.

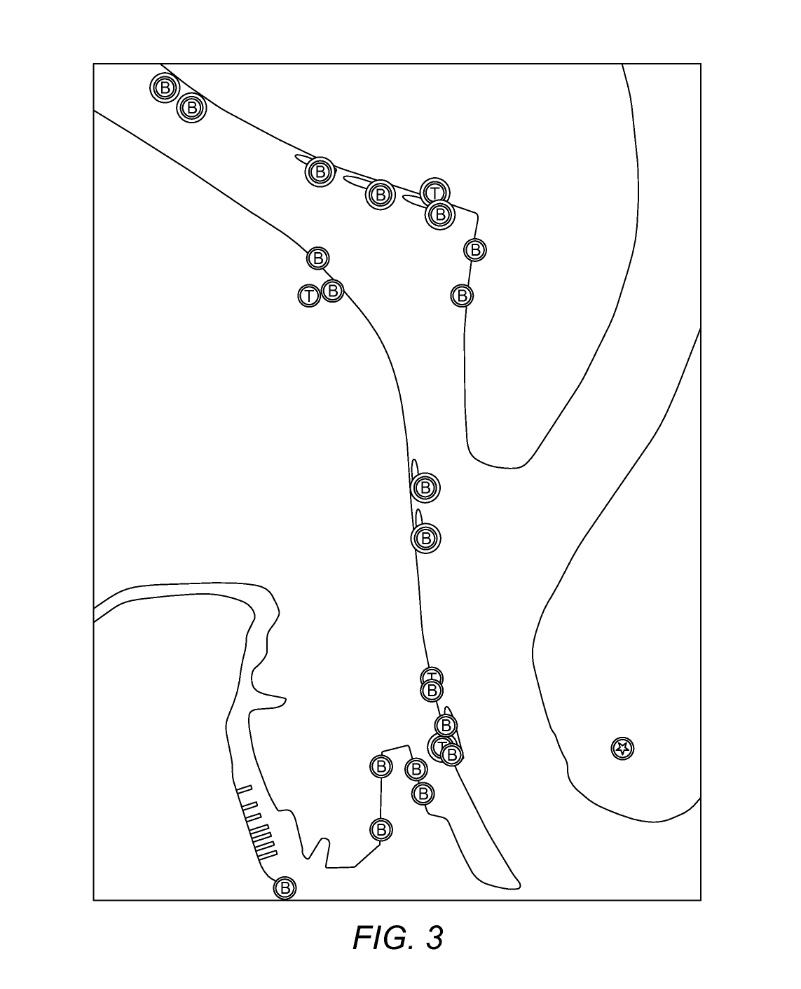

With reference to FIGS. 3 to 6, one embodiment of the invention will be described.

This embodiment comprises a berth database comprising berth location information and berth tagging information.

The berth database in this embodiment contains approximately 20,000 berth locations in ports around the world.

Berths are tagged within this database with commodity intelligence e.g. berth number 12345 at Newcastle is tagged as a coal berth.

FIG. 3 shows an example of berth locations mapped at Newcastle (Australia). The ‘B’ icons indicate geo-referenced berth locations and the ones highlighted with a circle are berths that have been tagged as ‘Coal’ loading berths.

This embodiment also includes a port zones database comprising an area for one of a plurality of ports and anchorages around the world defined by a polygon. In this embodiment, approximately 4000 port and anchorage zones are defined.

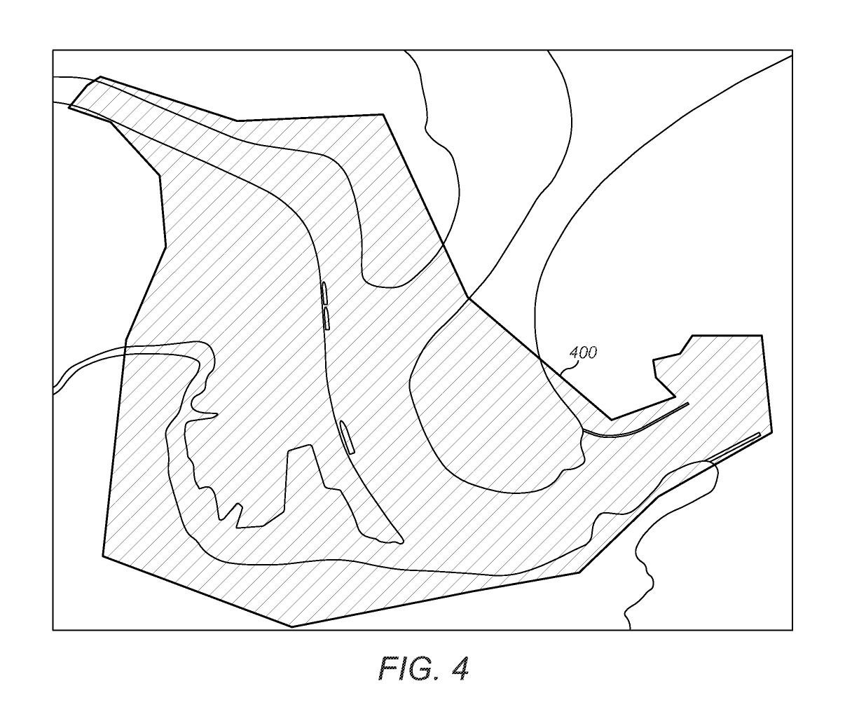

FIG. 4 illustrates an example of a mapped port zone at Newcastle (Australia) showing the area defined as 400.

In this embodiment, GPS locations of vessels are obtained by tracking their AIS transmissions.

The Automatic Identification System (AIS) is an automatic tracking system used on ships and by vessel traffic services (VTS) for identifying and locating vessels by electronically exchanging data with other nearby ships, AIS base stations, and satellites. When satellites are used to detect AIS signatures then the term Satellite-AIS (S-AIS) is used. AIS information supplements marine radar, which continues to be the primary method of collision avoidance for water transport.

Information provided by AIS equipment, such as unique identification, position, course, and speed, can be displayed on a screen or an ECDIS. AIS is intended to assist a vessel's watch standing officers and allow maritime authorities to track and monitor vessel movements. AIS integrates a standardized VHF transceiver with a positioning system such as a LORAN-C or GPS receiver, with other electronic navigation sensors, such as a gyrocompass or rate of turn indicator. Vessels fitted with AIS transceivers and transponders can be tracked by AIS base stations located along coast lines or, when out of range of terrestrial networks, through a growing number of satellites that are fitted with special AIS receivers which are capable of de-conflicting a large number of signatures.

The International Maritime Organization's International Convention for the Safety of Life at Sea requires AIS to be fitted aboard international voyaging ships with gross tonnage (GT) of 300 or more tons, and all passenger ships regardless of size.

The AIS transmissions from vessels are collected via a combination of land based antennas and satellites. These positional data are then consolidated into single de-conflicting positions at the datacenter for each vessel and that is then used as the time-stamped location of the vessel together with other data collected such as the vessel's current speed, heading draught, destination and estimated arrival date/time.

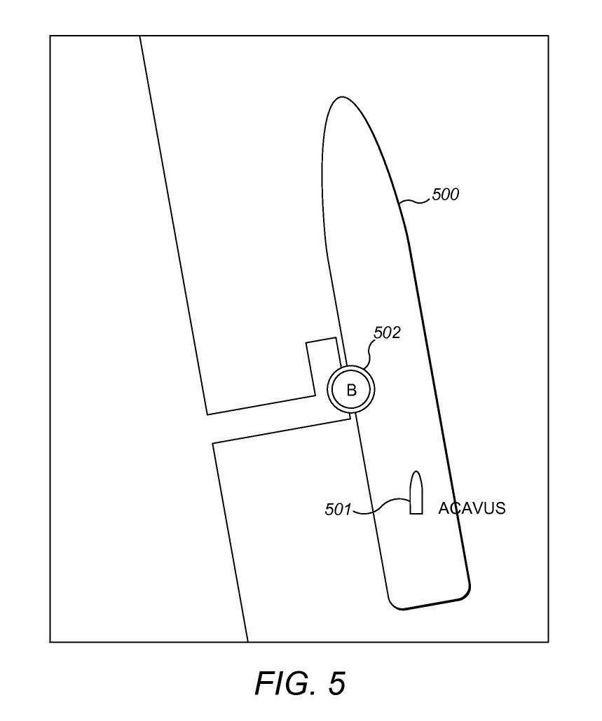

The AIS system provides a GPS location for the vessel from the position of the AIS transmitter. The AIS transmitter is most often on the bridge (at the back) of the vessel 500, as shown in FIG. 5 where 501 indicates the transmitter and 502 indicates the stored berth location. For this reason, it may be useful to utilize the length of vessel when determining whether the vessel is moored at a berth or within a geo-referenced port/anchorage zone.

This embodiment utilizes information from a vessel statistics database system called IHS Fairplay to obtain the vessel length. IHS Fairplay holds critical information on over 180,000 ships over 100 gross tons. IHS Fairplay is also the originating source for assigning IMO Ship and Company numbers.

International Maritime Organization (IMO) numbers are unique identifiers for ships and for registered ship owners and management companies. They were introduced under the SOLAS Convention to improve maritime safety and security and to reduce maritime fraud.

This embodiment comprises a pre-processing system to process the AIS transmissions and a processing system to match vessel positions to berth locations and port zones.

The pre-processing system for processing AIS transmissions receives AIS data from over 180,000 vessels via many terrestrial antennas and satellites. This data is de-duplicated and consolidated into single de-conflicting positions.

The processing system processes the data feed of consolidated AIS vessel positions together with the database of vessel statistics, the berth locations database and the port zones database to produce berth callings, port callings and inferred voyage intelligence data.

### Processing to Determine Berth Callings

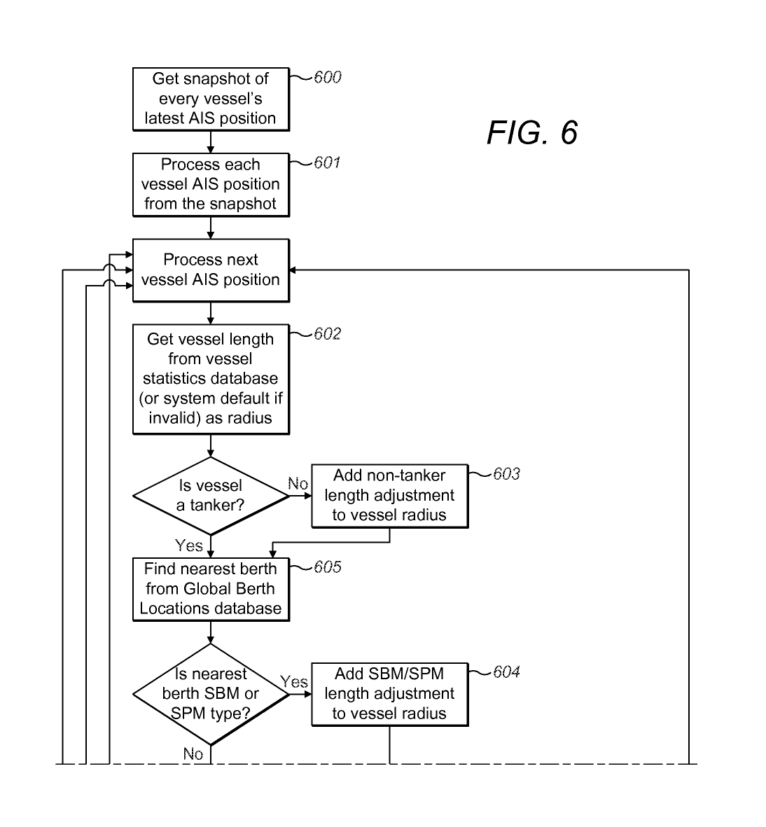

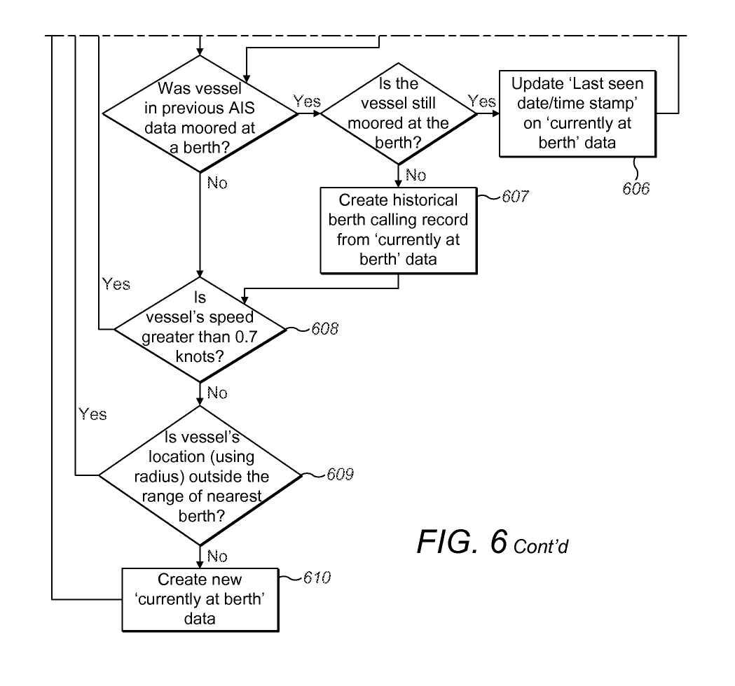

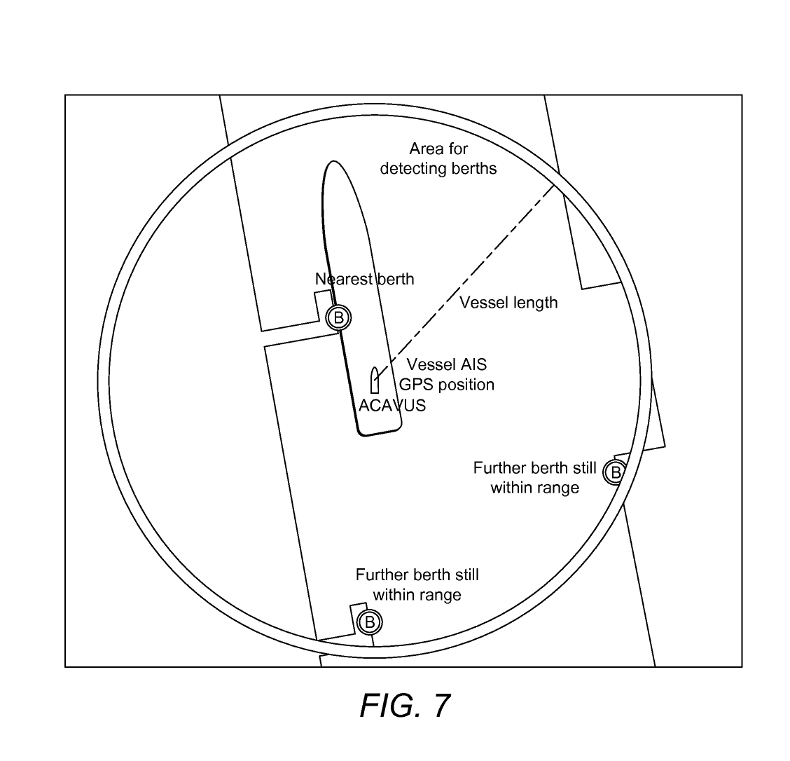

Utilizing the consolidated AIS data feed, vessel statistics database and the global berth locations database the following method, shown in FIG. 6, is used to create berth callings:
1) In step 600, a snapshot of every vessel position is taken from the consolidated AIS data feed every 15 minutes. This contains the last received AIS position and other AIS data from over 180,000 vessels.
2) In step 601, each vessel AIS data record is then processed in turn to determine whether or not the vessel is currently at a berth following the following rules
   a. As shown in FIG. 7, the vessel's length (from the Vessel Statistics Database) is used as a radius from each berths location (from the Global Berths Locations Database) to determine if the vessel is close enough to be deemed as moored at that berth
      i. If the vessel length in the Vessel Statistics Database is invalid (either zero or greater than 500 meters) then a default (system configurable) vessel length is used in step 602.
   b. If the vessel is not a tanker (determined from the Vessel Statistics Database) then an additional length (configurable) is added to the vessels length for the radius distance from the berth in step 603. This is because tankers moor near to fixed position connectors to off load liquid cargos whereas bulk vessels are not so precise in their mooring locations.
   c. If the berth is a SBM or SPM type (determined from the Global Berths Locations Database) then an additional length (configurable) is added to the vessels length for the radius distance from the berth in step 604. This is because SBM and SPM type berths are at sea and thus have no fixed point.
   A Single buoy mooring (SBM) (also known as single-point mooring or SPM) is a loading buoy anchored offshore, that serves as a mooring point and interconnect for tankers loading or offloading gas or liquid products. SPMs are the link between geostatic subsea manifold connections and weathervaning tankers. They are capable of handling any size ship, even very large crude carriers (VLCC) where no alternative facility is available.
   In an alternative embodiment, GPS location information for the SBM or SPM types are regularly received and integrated into the Berths Locations Database to provide accurate location information for these movable berths. In this embodiment, the additional length to be added is not required.
   d. In step 605, if more than one berth is within range of the vessel then the closest berth is used as shown in FIG. 7.
   e. A database is maintained of all vessels determined to be currently moored at berths and is used to calculate the arrival and departure date/time of every berth calling.
   f. If the vessel was previously determined to be moored at a berth i.e. currently at a berth then:
      i. If the vessel's AIS location is still within the calculated radius of that berth location then the ‘last seen timestamp’ data is updated from the AIS data onto the ‘Vessel currently at berth’ data record of that berth calling and the record is finished processing in step 606
      ii. If the vessel's AIS location is now outside the ‘current berth’ then a historical berth calling is created for the previous ‘currently at berth’ data in step 607. This data includes the arrival timestamp and arrival current draught data from the AIS data and the ‘last seen timestamp’ as the departure date/timestamp together with the current draught as the departure draught.
      Note that the ‘current draught’ of the vessel outside the berth is used as the departure draught—this is because vessels often update this data in their AIS transmissions after they have left the berth.
   g. In step 608, if the vessel's current speed (from AIS data) is greater than 0.7 knots then the vessel is not deemed to be moored and the record is finished processing.
   h. However, in step 609, if the vessel's current speed (from AIS data) is not greater than 0.7 knots and the vessel is within range of the nearest berth then a new ‘Vessel currently at berth’ database record is created in step 610. This record contains the AIS last seen timestamp as the berth arrival date/time stamp and the current draught as the berth arrival draught.

To calculate the nearest berth to a vessel a k-d tree algorithm may be used. A k-d tree (short for k-dimensional tree) is a space-partitioning data structure for organizing points in a k-dimensional space. k-d trees are a useful data structure for several applications, such as searches involving a multidimensional search key (e.g. range searches and nearest neighbor searches). k-d trees are a special case of binary space partitioning trees.

K-d tree processing is a binary tree search that can be used for multiple dimensions. It will be appreciated that other processing methods could be used to calculate the nearest berth location.

Distance calculations from the vessel to the nearest berth may be performed using the Haversine formula which uses a spherical approximation of the Earth. Values are known to differ from reality by as much as 0.3% and this is sufficiently accurate for the distance calculation.

It will be appreciated that other processing methods could be used to calculate the vessel to berth distances.

### Processing to Determine Port Callings

Anchorages are treated as separate zones to the ports and are recorded as ‘port callings’ but identified as the anchorage. This is because many vessels do not enter ports i.e. they only call at the anchorage and then smaller vessels come to the vessel to transport the vessel's cargo into the port.

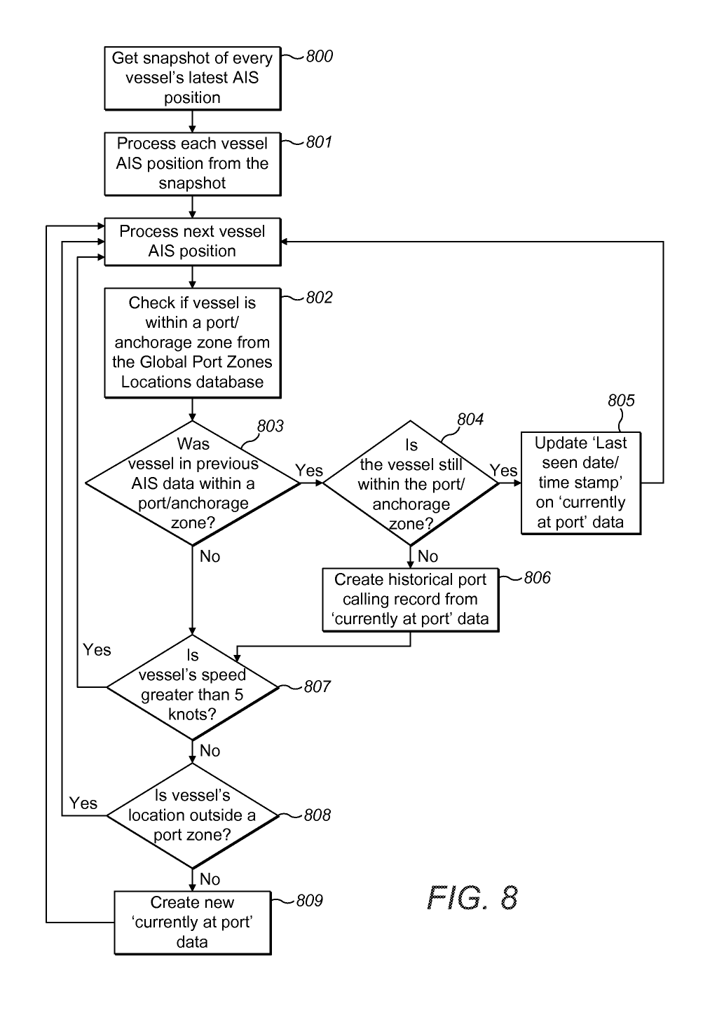

Utilizing the consolidated AIS data feed, vessel statistics database and the global port zones locations database the following method, as shown in FIG. 8, is used to create port callings:
1) In step 800, a snapshot of every vessel position is taken from the consolidated AIS data feed every 15 minutes. This contains the last received AIS position and other AIS data from over 180,000 vessels.
2) In step 801, each vessel AIS data record is then processed in turn to determine whether or not the vessel is currently within a port/anchorage zone following the following rules
   a. In step 802, the vessel's GPS position (from AIS) is checked to determine if it is within a port/anchorage zone.
      i. Port/anchorage zones are polygons defined by geo-referenced point held on the Global Port Zones locations database.
      ii. Port/anchorage zones do not overlap so a vessel can only be within a maximum of one port/anchorage zone at any one time.
      iii. A PNPoly algorithm is used to determine if the vessel GPS location point is inside a port/anchorage zone polygon. It will be appreciated that other algorithms can be used to determine a point within a polygon.
   b. A database is maintained of all vessels determined to be currently within port/anchorage zones and is used to calculate the arrival and departure date/time of every port calling.
   c. In step 803, if the vessel was previously determined to be within a port/anchorage zone i.e. currently at a port/anchorage then:
      i. In step 804, if the vessel's AIS location is still within the port/anchorage zone then the ‘last seen timestamp’ data is updated from the AIS data onto the ‘Vessel currently at port’ data record of that port calling and the record is finished processing at step 805.
      ii. If the vessel's AIS location is now outside the ‘current port’ then a historical port calling is created for the previous ‘currently at port’ data in step 806. This data includes the arrival timestamp and arrival current draught data from the AIS data and the ‘last seen timestamp’ as the departure date/timestamp together with the current draught as the departure draught.
      Note that the ‘current draught’ of the vessel outside the port is used as the departure draught—this is because vessels often update this data in their AIS transmissions after they have left the port.
   d. In step 807, if the vessel's current speed (from AIS data) is greater than 5 knots (note that this is a system configurable speed and is used to determine if the vessel is actually going to call at the port or is just sailing through the port/anchorage zone) then the vessel is not deemed to have called at the port and the record is finished processing.
   e. However, in step 808, if the vessel's current speed (from AIS data) is not greater than 5 knots and the vessel is within a port/anchorage zone then a new ‘Vessel currently at port’ database record is created in step 809. This record contains the AIS last seen timestamp as the port arrival date/time stamp and the current draught as the port arrival draught.

### Processing to Infer Cargo Type

Utilizing the berth callings and port callings vessel voyage records with the inferred cargo type are created.

The berth calling is used to determine the origin of the voyage and the next port calling is used to determine the destination of the voyage. Note that voyages may also be created for port to port callings where no berth calling was recorded but these are not used for berth tagging inferred cargo types.

The voyage is inferred with the cargo type tagged from the origin berth. Note that the destination berth calling may also be used in the reporting/analysis of these inferred intelligence voyages.

Utilizing the berth callings and port callings the following logic is used to create voyages with berth tagged inferred intelligence.

Separate processing is performed when a berth calling is recorded and when a port calling arrival is recorded.

Berth calling processing:
1) Every time a Berth Calling is recorded for a vessel then:
   a. A Voyage is created with the berth calling details as the origin. The voyage destination details are blank at this point.
   b. If the berth is tagged with cargo type (from the Berth Locations database) then the Voyage is also tagged with this cargo as inferred intelligence. The vessel's size and capacity (from the Vessel Statistics Database) is also appended to the intelligence and is used in reporting to estimate the size/capacity of the cargo (vessels are assumed to be fully loaded).

Port calling arrival processing:
1) Every time a vessel arrives at a port/anchorage (when a vessel is first recorded as currently at a port)
   a. If there is an open Voyage for the vessel (a voyage record with no destination) then the port calling is used to complete the destination details on the voyage record

### Database Records

The database records created and maintained for berth callings, port callings and berth tagged inferred cargo voyages during the above processing are:

### Vessels Currently at Berths

Berth identifier: unique key identifier of the berth in the Global Berth Locations Database
Vessel ID: the IMO or MMSI (see below) of the vessel is used from the Vessel Statistics database. Note that both the IMO and MMSI numbers are included within the AIS data transmitted by the vessels
Arrival date/time stamp: the first date/time stamp (from AIS data) of the vessel during its time moored at this berth calling
Arrival draught: the first value of the current draught (from AIS data) of the vessel during its time moored at this berth calling
Last seen date/time stamp: the most recent date/time stamp from AIS of the vessel during its time moored at this berth calling

### Historical Berth Callings

Berth identifier: unique key identifier of the berth in the Global Berth Locations Database
Vessel ID: the IMO or MMSI (see below) of the vessel is used from the Vessel Statistics database. Note that both the IMO and MMSI numbers are included within the AIS data transmitted by the vessels
Arrival date/time stamp: the first date/time stamp (from AIS data) of the vessel during its time moored at this berth calling
Arrival draught: the first value of the current draught (from AIS data) of the vessel during its time moored at this berth calling
Departure date/time stamp: the last date/time stamp (from AIS data) whilst the vessel was moored at the berth. Note this is the ‘last seen date/time stamp’ from the ‘vessels currently at berths’ when the vessel left the berth
Departure draught: this is the ‘current draught’ value (from AIS data) from the first AIS record after the vessel left the berth

### Vessels Currently at Ports

Port identifier: unique key identifier of the port in the Global Port Zones Locations Database
Vessel ID: the IMO or MMSI (see below) of the vessel is used from the Vessel Statistics database. Note that both the IMO and MMSI numbers are included within the AIS data transmitted by the vessels
Arrival date/time stamp: the first date/time stamp (from AIS data) of the vessel during its time recorded at this port calling
Arrival draught: the first value of the current draught (from AIS data) of the vessel during its time recorded at this port calling
Last seen date/time stamp: the most recent date/time stamp from AIS of the vessel during its time recorded at this port calling

### Historical Port Callings

Port identifier: unique key identifier of the port in the Global Port Zones Locations Database
Vessel ID: the IMO or MMSI (see below) of the vessel is used from the Vessel Statistics database. Note that both the IMO and MMSI numbers are included within the AIS data transmitted by the vessels
Arrival date/time stamp: the first date/time stamp (from AIS data) of the vessel during its time recorded at this port calling
Arrival draught: the first value of the current draught (from AIS data) of the vessel during its time recorded at this port calling
Departure date/time stamp: the last date/time stamp (from AIS data) whilst the vessel was recorded at the port. Note this is the ‘last seen date/time stamp’ from the ‘vessels currently at ports’ when the vessel left the port
Departure draught: this is the ‘current draught’ value (from AIS data) from the first AIS record after the vessel left the port
   Vessel Voyages (with Berth Tagged Inferred Intelligence)
Vessel ID: the IMO or MMSI (see below) of the vessel is used from the Vessel Statistics database. Note that both the IMO and MMSI numbers are included within the AIS data transmitted by the vessels
Origin identifier: unique key identifier of the origin berth in the Global Berth Locations Database (from berth callings record)
Origin departure date/time: the departure date/time when the vessel departed the berth (from berth callings record)
Origin departure draught: the departure draught value of the vessel (from the berth callings record)
Destination identifier: unique key identifier of the port in the Global Port Zones Locations Database (from currently at port callings record)
Destination arrival date/time: the arrival time when the vessel arrived at the destination port (from currently at port callings record)
Destination arrival draught: the arrival draught of the vessel (from the currently at port callings record). Note that this should be identical to the origin departure draught but as draughts are often only updated after the vessel has left its origin the destination arrival draught is often much more reliable.
Cargo Volume: the vessel capacity (from the Vessel Statistics database). This is the square metres capacity—gas capacity for gas type vessels (LNG and LPG tankers) and liquid capacity for all other tankers
Cargo Weight: the vessel's deadweight (from the Vessel Statistics database)
Cargo Commodity: the inferred commodity (from the Global Berth Locations database. This the high level description of the cargo e.g. Oil, Coal etc.
Cargo Grade: the inferred grade of the commodity (from the Global Berth Locations database). This is a more specific grade of the commodity e.g. ‘Coking coal’
Cargo Specific Grade: The inferred specific grade (from the Global Berth Locations database). This is any specific grade intelligence data within the grade e.g. This could be the kcal/kg (energy value) of coal.

The Maritime Mobile Service Identity (MMSI) is a series of nine digits which are sent in digital form over a radio frequency channel in order to uniquely identify ship stations, ship earth stations, coast stations, coast earth stations, and group calls. These identities are formed in such a way that the identity or part thereof can be used by telephone and telex subscribers connected to the general telecommunications network to call ships automatically.

In one embodiment, the berths may include Floating storage vessels. A floating production, storage and offloading (FPSO) unit is a floating vessel used by the offshore oil and gas industry for the processing of hydrocarbons and for storage of oil. An FPSO vessel is designed to receive hydrocarbons produced from nearby platforms or subsea template, process them, and store oil until it can be offloaded onto a tanker or, less frequently, transported through a pipeline. FPSOs are preferred in frontier offshore regions as they are easy to install, and do not require a local pipeline infrastructure to export oil. FPSOs can be a conversion of an oil tanker or can be a vessel built specially for the application. A vessel used only to store oil (without processing it) is referred to as a floating storage and offloading vessel (FSO). There are also under construction (as at 2013) Floating Liquefied Natural Gas (FLNG) vessels, which will extract and liquify natural gas on board.

A potential advantage of some embodiments of the present invention is that it facilitates tracking of cargo between locations without requiring the collection and transmission of direct cargo information. A further potential advantage of some embodiments of the present invention is that this inferred cargo intelligence of what vessels are carrying, or have carried, may be valuable to those trading in those commodities as it assists them in making more informed trading decisions by monitoring current and historic flows of those commodities between ports, countries and regions.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of applicant's general inventive concept.

1. A method of tracking cargo at a processing system, including:
a) determining whether a vessel has berthed at one of a plurality of berths, each berth tagged with a commodity type;
b) receiving information about the vessel;
c) determining whether the vessel has called at a port; and
d) utilising the berth tag and information about the vessel to calculate the quantity of a commodity delivered between the berth and the port.

2. A method as claimed in claim 1, wherein the information includes draught information received from the vessel.

3. A method as claimed in claim 1, wherein the information includes information relating to the capacity and/or size of the vessel.

4. A method as claimed in claim 1, wherein the step of determining whether the vessel is berthed includes determining whether location coordinates for the vessel correspond to the location coordinates for the berth.

5. A method as claimed in claim 4, wherein the berth correspondence process utilises the length of the vessel.

6. A method as claimed in claim 4, wherein the berth correspondence process utilises the type of berth.

7. A method as claimed in claim 4, wherein the step of determining whether the vessel is berthed includes determining whether the velocity of the vessel is below a predefined threshold.

8. A method as claimed in claim 1, wherein the step of determining whether the vessel has called at the port includes determining whether location coordinates for the vessel correspond to a location within a polygon area defined for the port.

9. A method as claimed in claim 8, wherein the port correspondence process utilises the length of the vessel.

10. A method as claimed in claim 8, wherein the step of determining whether the vessel has called at the port includes determining whether the velocity of the vessel is below a predefined threshold.

11. A method as claimed in claim 1, wherein the vessel departs from the berth for arrival at the port.

12. A system for tracking cargo, including:
a processing system configured for determining whether a vessel has berthed at one of a plurality of berths, each berth tagged with a commodity type, receiving information about the vessel, determining whether the vessel has called at a port, and utilising the berth tag and information about the vessel to calculate the quantity of a commodity delivered between the berth and the port;
a berth database configured for storing information about a plurality of berths; and
a port database configured for storing information about a plurality of ports.
